(19) United States
(12) Patent Application Publication
(10) Pub. No.: US 2008/0180354 A1
(43) Pub. Date: Jul. 31, 2008

(54) PROCESS FOR OPERATING A DISPLAY DEVICE WITH A MULTITUDE OF PICTURE ELEMENTS, WHICH ARE SUBJECT TO WEAR, DEVICE FOR CORRECTING AN ACTIVATION SIGNAL FOR A DISPLAY DEVICE, AND DISPLAY DEVICE

(75) Inventor: Carsten Kienhoefer, Karlsruhe (DE)

Correspondence Address: BRINKS HOFER GILSON & LIONE, P.O. BOX 10395, CHICAGO, IL, 60610, US

(73) Assignee: Ingenieurburo Kienhofer GmbH, Karlsruhe (DE)

(21) Appl. No.: 11/942,911

(22) Filed: Nov. 20, 2007

Related U.S. Application Data
(63) Continuation of application No. PCT/EP2006/002946, filed on May 20, 2005.

(30) Foreign Application Priority Data
May 20, 2005 (DE) 10 2005 024 769.5

(51) Int. Cl. G09G 3/20

(52) U.S. Cl. 345/55

(57) ABSTRACT

The disclosure relates to a method for operating a display device (100) with a plurality of pixels (p)—preferably arranged in matrix form—beset by wear, in which each pixel (p) has applied to it a drive signal (S) assigned to it, in which a wear value (V) as a measure of the individual wear of the respective pixel (p) is determined for each pixel (p) depending on the drive signal (S), and in which a correction value (K) for correcting the drive signal (S) is determined depending on the wear value (V), characterized in that the process of determining the wear value (V) has certain steps as set forth in the disclosure.

### CROSS-REFERENCE TO RELATED APPLICATIONS

This application is a continuation of International Application No. PCT/EP2006/002946 filed on Mar. 31, 2006, which claims the benefit of DE 10 2005 024 769.5, filed May 20, 2005. The disclosures of the above applications are incorporated herein by reference.

### FIELD

The disclosure concerns a process for operating a display device with a multitude of picture elements subject to wear and arranged in matrix form. The disclosure also concerns a device for correcting an activation signal for a display device, which has a multitude of picture elements subject to wear and arranged in matrix form.

### BACKGROUND

The statements in this section merely provide background information related to the present disclosure and may not constitute prior art.

Processes and devices such as those set forth above are used, for example, in plasma screens, in order to counteract or compensate for the signs of wear produced by parasitic effects. A first undesirable effect during the operation of a plasma screen consists of the so-called burning in, which is already known from CRT displays, and in which there is a reduction of an electrical/optical conversion efficiency of the illuminant comprising phosphorous compounds in the plasma screen, above all in the picture elements of the plasma screen in which previously the same bright image, such as, for example, a logo superimposed on a television picture, has been displayed for a long time. This causes the logo that has been superimposed for a long time to also be seen in the form of a contrast difference with respect to the remaining areas or display elements of the plasma screen, when an actual display of the logo in the television picture no longer takes place.

A further undesirable effect during the operation of a plasma screen consists of the different illuminants allocated to the respective primary colors in color screens aging differently, so that undesirable changes in the color representation result over the service life of a color screen such as this.

From DE 100 10 964 A1 there is known a plasma display device which has an efficiency factor determination circuit, that integrates the amplitude levels and durations of RGB level signals, in order to determine an efficiency factor of the plasma display. The white balance activation signals corresponding to the efficiency factor are displayed on an RGB signal amplifier.

Known from DE 101 13 248 A1 is a process for compensating the burning-in of plasma screens in which the degree of stress of the individual pixels is measured in a first type of operation, and in which the content of the memory component is read out in a second type of operation, in order to determine the pixel with the highest stress. In a subsequent compensation phase, the remaining pixels are actuated so greatly that they have the same degree of stress at the end of the compensation phase as they once had at the most stressed pixel.

From EP 1 376 520 A1 there are known a process and a device for the compensation of the burning-in effect in plasma screens, in which a number of activation pulses is integrated in a first step, with which a cell of the plasma screen is controlled. Corresponding correction factors are formed in a second step. Six bits of a data element to be stored are respectively cut off, in order to reduce a data volume to be stored.

Known from United States patent application 2003/0063053 A1 is a display device, in which the data is determined via a single picture element of the display device and in which the corrections dependent on the wear data are formed during the activation of the display device.

None of the operating procedures known from the state of the art or none of the known devices make possible a precise determination of the wear data of a plasma screen. A data rate predetermined by means of the corresponding activation signal, which must be evaluated, in order to determine the wear values, is so great that a conventional processing with popular computer units or memory elements and their memory bandwidths is not possible without previously reducing the data volume to be processed, for example, by cutting low value bits during the storage of the wear data, especially in plasma screens with a high resolution, such as, for example, a resolution of 1360*765 pixels or picture elements. This leads to a corresponding accuracy loss.

### SUMMARY

Accordingly, in one form the disclosure improves the process and the device of the type described above, so that a precise determination of the wear data of the display device with a simultaneous use of less complex computer units or conventional memory elements is possible.

This is attained with the process of the type described above, which comprises the following steps for determining the wear value:

Adding chronologically consecutive values of the activation signal allocated to the picture element, in order to obtain a primary wear value,

Storing the primary wear value in a primary memory,

At least partially transferring the primary wear value by reducing the primary wear value by a predetermined transfer value and by adding the transfer value to a secondary wear value stored in a secondary memory.

The division of the wear value according to the disclosure into a primary wear value and a second wear value or the provision according to the disclosure of the primary memory and the secondary memory allow a processing of the activation signal or a determination of the wear value with a maximum accuracy, while an efficient memory utilization is simultaneously ensured.

A volatile memory, for example, a memory configured as an SDRAM memory, is preferably used according to the disclosure as primary memory. A preferable secondary memory is a non-volatile memory, such as, for example, a flash EEPROM memory.

A memory configuration of this kind provides, on the one hand, the use of a particularly fast primary memory in the form of the SDRAM memory, while the secondary memory in the form of the flash EEPROM allows a non-volatile storage of data. In general, other volatile or nonvolatile memory types can also be used, such as, for example, MRAM memories or also FeRAM memories.

According to the disclosure, the successively following values of the activation signal allocated to a picture element, which have a relatively high data rate, are stored in the fast primary memory after the addition step, so that an excessive wear and therefore an unnecessary reduction of the service life of the secondary memory is prevented.

In order to still keep the memory requirements as low as possible, at least one part of the primary wear values is transferred according to the disclosure into the secondary memory by means of the transfer step, and is stored there in the form of the secondary wear value. It is advantageous according to the disclosure to only transfer a predetermined number of high-value bits of the primary wear value into the secondary memory during the transfer. In this way, a data volume to be transferred from the primary memory into the secondary memory is also reduced.

A further advantage of the mode of operation according to the disclosure consists of the portion of the primary wear value that is not to be transferred into the secondary memory, that is, for example, the low-value bits of the primary wear value, not being discarded, but still remains stored in the primary memory, so that a maximum attainable accuracy of the process according to the disclosure is maintained.

In a further advantageous embodiment of the disclosure, it is provided that the transfer value is divided by a predetermined divisor value in the step of an at least partial transfer of the primary wear value of the wear value, in order to obtain a reduced transfer value, and that the reduced transfer value is added to a secondary wear value stored in a secondary memory.

That is, even though the transfer value is subtracted from the primary wear value, at the same time only the reduced transfer value is added to the secondary wear value stored in the secondary memory. Two advantages result in this way: The addition or storage of the primary wear values in the primary memory is still carried out with a maximum accuracy, because also the low-value bits of the primary wear values are taken into account in each addition. On the other hand, a value is added to the secondary wear value with the reduced transfer value, which is smaller than the transfer value subtracted from the primary wear value, so that the secondary wear value grows on average less fast than the primary wear value.

The accuracy loss which results from the transfer value to the reduced transfer value is thereby negligible. In contrast to the conventional processes, the accuracy loss produced by a use of the reduced transfer value occurs namely only during the transfer step, which (as described below in further detail), is carried out relatively seldom in comparison with the steps of the addition and storage of the primary wear value. In customary processes, one part of the value to be stored, for example, its low-value bits, is not taken into account already during the addition and storage of a value comparable to the primary wear value, so that an accuracy loss of, for example, 6 bits, is already present during the addition, which accordingly adds up over time.

A power of two is used as divisor value in an especially useful manner during the process according to the disclosure, so that the reduced transfer value can be determined in an especially efficiently manner.

The transfer step according to the disclosure is carried out in a particularly advantageous embodiment after reaching a predetermined condition, especially after a maximum primary wear value has been exceeded and/or after a predetermined waiting time has expired. In this way, it is ensured that an overflow, and therewith a data loss of wear values, does not occur in the primary memory through the addition of the chronologically consecutive values of the activation signal, while it is ensured at the same time, that the transfer step does not occur just as frequently as, for example, the addition that is regularly carried out for each consecutive value of the activation signal in connection with the primary wear value. In this way, the number of write-accesses to the secondary memory is reduced to a minimum, which considerably increases the service life of the secondary memory as flash EEPROM in particular during a formation thereof.

23 bits are provided, for example, in a 32-bit memory cell of the primary memory for the storage of the primary wear value in a preferred embodiment of the disclosure, in which the activation signal has, for example, at least one color channel with a resolution of, for example, 8 bits.

Based on a picture frequency of the plasma screen of 60 Hz, in which each picture element is thus actuated sixty times per second by means of an activation signal comprising a value range of 2̂8=256, there results an increase of the primary wear value by a value of 60*255=15300 with a permanent maximum brightness activation of the picture element per second. This means that the maximum value range for the primary wear value of 2̂23=8388608 during a permanent activation of a considered picture element such as this with a maximum possible brightness is reached after about 548 seconds. The transfer according to the disclosure of the primary wear value into the secondary wear value should be carried out at the latest after this time, whereby the primary wear value is reduced and the activation signal values can again be added thereto.

In an advantageous variation of the process according to the disclosure, a weighting of the values to be added is carried out before the addition during the step in which the chronologically consecutive values of the activation signal allocated to the picture element are added. In this way, it is possible to take into account any non-linearities in the wear of the picture elements.

A picture element can suffer a different actual wear during two mutually consecutive activations with half brightness than with a single activation with full brightness and a subsequent activation with minimal brightness or vice versa. The same wear value would have to be determined, however, in both cases without the weighting according to the disclosure, while a weighting of the respective values of the activation signal can take into account a possibly existing non-linear wear behavior of the picture element.

Other influences that act on the wear behavior, such as, for example, an ambient temperature and the like can be taken into account, for example, via a weighting of this kind before the addition. Appropriate weighting factors can be obtained from characteristic curves and characteristic fields.

In addition, the influence of a plasma display controller can also be emulated by means of this weighting, which performs, for example, a gamma correction of the activation signal that is fed to it, and activates the plasma screen with a correspondingly modified activation signal. By means of the reproduction of such a modification of the activation signal according to the disclosure, it is ensured that the process according to the disclosure works also with an activation signal which is actually fed to the plasma screen.

The chronologically consecutive values of the corrected activation signals allocated to the picture element are added in an advantageous way in a further embodiment of the process according to the disclosure, in order to obtain the primary wear value. Since the activation signal according to the disclosure is corrected and the display device is thus operated with a corrected activation signal, a precise determination of the actual wear of the display device is possible in this way.

The primary wear value of a picture element and a correction value allocated to this picture element are simultaneously stored in a memory cell of the primary memory in another advantageous embodiment of the process according to the disclosure. In this way, it is possible to access both values, that is, to gain access to the primary wear value and the corresponding correction value according to the disclosure with only one single memory access, that is, within one reading cycle of the primary memory.

The primary wear value is herein preferably recorded in a m_1 number of preferably high-value bits of the memory cell, while the correction value is recorded in a m_2=m−m_1 number of preferably low-value bits of the memory cell.

A separation of the primary wear value form the correction value after a reading of the respective memory cell is possible in a conventional manner, for example, using predetermined bitmasks.

In a variation of the disclosure, the steps of the addition and storage in the primary memory are separated in an advantageous manner at different times from/or asynchronously with respect to the step of the at least partial transfer. As already described, the transfer step is preferably carried out after reaching a predetermined condition, for example, when the primary wear value has reached a maximum predetermined value. On the one hand, because of the random character of the values of the activation signal which is added in the primary memory, the time at which the aforementioned maximum predetermined value is reached is chronologically not able to be accurately determined. With the numerical examples described above involving a permanent maximum brightness activation of a picture element result, for example, about 548 seconds as maximum length for a time interval before the transfer according to the disclosure is to be carried out.

On the other hand, the chronological decoupling of the steps of adding and storing in the primary memory according to the disclosure from the transfer step makes it possible to always carry out the transfer according to the disclosure into the second memory when, for example, a sufficient computing power is available or when no ulterior calculation steps of higher priority are required.

According to a further process variation of the disclosure, the steps of adding and storing in the primary memory are carried out with a processing speed that corresponds to the data rate of the activation signal. In this way, it is possible to carry out the addition of the values of the activation signals without providing an additional intermediate storage, because the primary wear value can be stored directly in the primary memory. It is particularly practical, therefore, to use a memory type with a high memory bandwidth, because the data rate of the activation signal can assume values of, for example, up to a few hundred megabytes per second.

The primary wear values allocated to the individual picture elements are stored according to the disclosure in the primary memory in a manner corresponding to the chronological order of the values of the activation signal.

The activation signals allocated to the individual picture elements are usually transferred sequentially, that is, one after the other, in an activation signal configured, for example, as an RGB signal. A storage in the same order requires a correspondingly low processing effort.

In a further advantageous embodiment of the disclosure, the at least partial transfer from the primary wear value to the secondary wear value is carried out with a lower processing speed than the addition and storage in the primary memory.

The secondary wear values are stored block-by-block in the secondary memory. A storage such as this by means of a bundling of individual values to be stored block-by-block (which are to be temporarily stored, if required) contributes to the maximization of the service life of the secondary memory because most flash EEPROM memory components provide for a storage preferably block-by-block and because in a storage that is not block-by-block unnecessary memory cells must accordingly be written, which overall reduces the service life of the secondary memory.

In a further advantageous embodiment of the process according to the disclosure, a block identifier is stored for each stored block in the secondary memory together with the secondary wear values stored block-by-block. A predetermined number of secondary wear values, which can be again read out from the secondary memory using the block identifier, is allocated to the respective block identifier.

A check sum can further be advantageously allocated to several secondary wear values, and this check sum can likewise be recorded in the secondary memory. In this way, depending on the length or bit number of the check sum and the number of wear values for each check sum, it is possible to detect or even correct, for example, bit errors that occurred during storage. The service life of a secondary memory configured, for example, as a flash EEPROM is further increased therewith.

In the previously described block-by-block storage, it is conceivable, for example, to form a check sum via eight secondary wear values, respectively, wherein these eight secondary wear values and the corresponding check sum form one of several partial blocks, which together represent, in turn, one block, which is written in addition during the block-by-block storage in the secondary memory.

In a further advantageous embodiment of the process according to the disclosure, the step of the addition and the storage comprises the following steps:
Reading out a primary wear value already stored in the primary memory,
Adding the current value of the activation signal allocated to the picture element to the previous primary wear value in order to obtain a current primary wear value, and
Storing the current primary wear value in the form of the primary wear value.

In a further variation of the process according to the disclosure, the step of adding the transfer value comprises the following steps:

Reading out a secondary wear value already stored in the secondary memory,

Adding the transfer value to the previous secondary wear value, in order to obtain a current secondary wear value, and

Storing the current secondary wear value in the form of the secondary wear value.

In a further embodiment of the process according to the disclosure, the transfer step is carried out before the activation of the display device, whereby the primary wear values are transferred into the secondary memory. In contrast to the regular transfer of a part of the primary wear value in the form of the transfer value, the primary wear value is hereby preferably transferred entirely, that is, the high-value as well as the low-value bits, into the secondary memory. In this way, the once determined primary wear values can also be received during a deactivation of the display device in the non-volatile secondary memory, in order to be reused with a renewed activation of the display device.

It is further possible to also transfer the correction values into the secondary memory before the display device is deactivated. As an alternative to this, it is also possible to calculate the correction values anew each time, when the display device is activated. A calculation such as this is relatively less complex. The advantage is furthermore created, that no memory space is occupied by the correction values in the secondary memory, so that an entire memory cell, for example, a memory cell having 32 bits, can be used for storing the secondary wear value.

A further process variation of the disclosure provides that after an activation of the display device, first the secondary wear values stored in the secondary memory are transferred at any rate at least partially into the primary memory. In this way, it is ensured that a further determination of wear values is built on the previously determined wear values and thus reflects the actual wear of the display device. If required, the correction values that are recorded in the secondary memory can likewise be transferred into the primary memory after an activation of the display device. The transfer of the secondary wear values into the primary memory can, however, also be preferably omitted, in order to leave free a maximum memory space in the primary memory for storing newly determined primary wear values.

Used as activation signal, for example, is an RGB signal emitted by a graphic card. As an alternative to this, it is also possible to use a pulse frequency as an activation signal, with which the plasma pulse generator of the display device actuates the individual picture elements. In this way a particularly precise measurement of the wear values is ensured, because the pulse frequency for activating the individual picture elements represents the signal with which the picture elements are actually activated. In contrast to this, when using an RGB signal as the activating signal, it can occur, that a plasma display controller, which receives the RGB signal as input signal, carries out internal corrections on the RGB signal, such as, for example, a gamma correction or a limitation of the maximum brightness or a scaling of the picture to be displayed, so that an actually used pulse frequency for activating the picture element no longer corresponds to the RGB values of the activation signal and the wear values determined based on the RGB values deviate from the actual demands of the picture element.

In an exemplary embodiment of the disclosure, the determination of the correction value uses the following steps:

Reading in the wear value, preferably the secondary wear value stored in the secondary memory,

Determining a correction value corresponding to the read-in wear value which is fed for this purpose to the read-in wear value, by means of a characteristic line or a characteristic field.

The characteristic line or characteristic field can represent hereby a connection between a wear to which the plasma screen is subjected and between a corresponding correction factor, with which the activation signal is to be corrected, in order to make possible a display of a picture which has been purged from wear on the plasma screen.

Aside from the multiplicative linkage of the correction value with the activation signal, it is also possible to add a correction value to the activation signal.

In a further advantageous embodiment of the disclosure, the characteristic line allocates a wear value interval having at least one wear value to each possible correction value. A correction value allocated to the read-in wear value can then be determined by determining that wear value interval in which the read-in wear value is located.

8 bits can be provided according to the disclosure, for example, in order to represent a correction value, so that a total of 256 different correction values is possible. Each of these 256 different correction values is allocated an interval of wear values according to the disclosure. In a representation of the wear values by means of 32 bits there results a value range for the wear values of 2̂32, so that a number of about 2̂32/2̂8=2̂24 different wear values is allocated to one correction value with a uniform distribution. A wear value interval extending from 0 to 2̂24−1 is then allocated, for example, to the smallest possible correction value, a wear interval extending from 2̂24 to 2*2̂24−1 is allocated to the next smallest correction value, et cetera.

If the limits of the wear value intervals are known, the wear value interval in which the read-in wear value is located can be determined within the scope of, for example, a linear search, starting from the read-in wear value for which a matching correction value is to be determined. A correction value allocated thereto will then be obtained by means of the characteristic line.

The wear value interval in which the read-in wear value is located can be determined by means of a binary search of the wear value intervals, whereby a less time and effort is incurred like in the linear search.

In a further embodiment of the disclosure, it is provided that the correction value is determined depending on a characteristic line, which indicates a connection between the wear of a picture element, especially between the secondary wear value, and a residual brightness with the maximum activation of the picture element.

A lookup table is dynamically formed in a particularly advantageous way, which has a correlation between the correction values and/or residual brightness values and the wear values. A value range comprised by the lookup table is preferably determined depending on the arising wear values. In this way, the lookup table can be constantly adapted to a current wear situation and a maximum accuracy in the determination of the correction values can be ensured therewith, which cannot be attained with a statistic characteristic line or table.

The determination of the correction values based on the wear values of the lookup table can be carried out, for example, in the way of a linear or preferably binary search.

According to another advantageous embodiment of the disclosure, a program code, which is provided for the implementation of the process according to the disclosure on a computer unit of the device according to the disclosure or the display device, is stored in the secondary memory. In the configuration of the secondary memory according to the disclosure as flash EEPROM, a simplified design of the display device according to the disclosure arises through the dual use of the secondary memory because a separate program memory is not provided for the computer unit.

In a further embodiment of the process according to the disclosure, a predetermined number of low-value bits of the activation signal is not used for the determination of the primary wear value.

Advantageously, the corrected activation signal has the same value range and/or at least the same resolution as the activation signal in a further embodiment of the disclosure.

It is also possible to provide the correction value with a lower resolution than the activation signal, preferably a resolution that is lower by one bit.

The determination of the correction value is advantageously carried out at different times from and/or asynchronously with respect to the steps of the addition and the storage in the primary memory in a further embodiment of the process according to the disclosure. The determination of the correction value can be likewise carried out at different times from and/or asynchronously with respect to the step of the at least a partial transfer. For a sufficient compensation of the wear of the plasma screen, it is entirely sufficient to calculate new correction values, for example, at intervals of one day.

In a further embodiment of the disclosure, the primary wear value and/or the secondary wear value and/or the correction value are subjected to a differential coding and/or an entropy coding, especially before the storage. In this way, a preferably loss-free data reduction can be achieved, when there is a sufficient computing power, whereby the size of the primary memory or the secondary memory can be reduced.

According to the disclosure, the correction value can be stored in the primary memory as well as in the secondary memory.

In a further advantageous embodiment of the process according to the disclosure, a picture element is activated with a special activation signal depending upon the wear value allocated to it, wherein the special activation signal has particularly higher values than the normal activation signal or than the corrected activation signal, in order to accelerate a wear of the picture element. By means of this accelerated wear, it is possible to age or wear in a targeted manner the picture elements that until now had been subjected to a lower wear in order to produce an adaptation of these picture elements to the already strongly worn picture elements.

The picture elements that are to be worn intentionally in this way can be determined according to the disclosure based on the wear value and/or the correction value allocated to them. A wear value or correction value averaged over all the picture elements of the display device can be formed, for example, and it can then be determined based on a comparison of the wear value or correction value of a single picture element with the averaged wear value or correction value, whether the considered picture element should be intentionally worn or not.

In a further process variation according to the disclosure, the reading and/or writing accesses of the primary memory are carried out in the form of burst accesses, in which respectively a multitude of memory cells are read or written. In these burst accesses, a memory address and a number of memory cells, which are to be read-in or written one after the other in the burst access must be indicated only once; a logic, which is integrated in the memory component, ensures, that the respective memory cells can be read out or written without requiring a separate selection of each individual memory cell for this purpose, as is the case in non-burst accesses.

A number of memory cells that corresponds to a power of two are usually read or written in one burst access in conventional memory components. If, however, a memory number of memory cells that is different from the power of two is to be written in the memory cells with primary wear values in the memory component, a number of memory cells corresponding to the difference of the memory number and the number of memory cells corresponding to the power of two with control values and/or with at least one check sum are written according to the disclosure, so that also the memory cells of the primary memory which are not required for storing the primary wear values can be practically used, for example, in order to realize mechanisms for error correction. The correction data can also have special bit patterns, for example, alternating the binary digits ‘0’ and ‘2’, which can be verified with a renewed reading-in of these data, from which can be ascertained, for example, a reliability of the used memory component.

Additionally, it is now proposed to simultaneously also store in a memory cell of the primary memory in addition to the primary wear value of a picture element a correction value allocated to this picture element in a device pursuant to the preamble of patent claim 48.

It is particularly advantageous to equip the device according to the disclosure with a computer unit, which can be especially configured as a microcontroller and/or as a digital signal processor and/or as a programmable logic component, especially as a FPGA (Field Programmable Gate Array) and/or as an application-specific integrated circuit (ASIC, Application Specific Integrated Circuit).

An integration of the device according to the disclosure in the display device or, for example, in a plasma display controller located in the display device is also particularly advantageous.

A further approach according to the disclosure is disclosed by means of a display device pursuant to patent 55.

Advantageous embodiments of the process according to the disclosure and the device according to the disclosure are contained in the dependent claims.

Further advantages, features, and details of the invention can be drawn from the following description, in which different exemplary embodiments of the invention are represented with reference to the drawings. The features mentioned in the claims and in the description can be considered a part of the invention per se or in any desired combination.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

In order that the invention may be well understood, there will now be described an embodiment thereof, given by way of example, reference being made to the accompanying drawing, in which:

FIG. 1 shows a first embodiment of a device according to the disclosure;

FIG. 2 shows a schematic representation of the picture elements of a plasma screen;

FIG. 3 shows a memory cell of the primary memory of the device according to the disclosure;

FIG. 4 shows a further embodiment of the disclosure;

FIG. 5 shows a simplified flow diagram of a first embodiment of the process according to the disclosure;

FIG. 6a shows respectively one memory cell of the primary and secondary memory before the transfer according to the disclosure;

FIG. 6b shows the memory cell of the primary and secondary memory of FIG. 6a after a transfer according to the disclosure;

FIG. 6c shows the memory cell of the primary and secondary memory of FIG. 6a after a reduced transfer according to the disclosure;

FIG. 7 shows a flow diagram of a further process variation according to the disclosure;

FIG. 8a shows a flow diagram of a further process variation according to the disclosure;

FIG. 8b shows a flow diagram of a further process variation according to the disclosure;

FIG. 9a shows a simplified flow diagram, which represents the signal flow during the correction of the activation signal according to the disclosure;

FIG. 9 shows wear value classes for the determination of a correction value;

FIG. 10a shows a characteristic line, which represents the wear characteristics of an illuminant;

FIG. 10b shows a histogram, from which can be read out the residual brightness values of a used plasma screen; and

FIG. 11 shows a table according to the disclosure for the representation of the characteristic line of FIG. 10a.

### DETAILED DESCRIPTION

The following description is merely exemplary in nature and is not intended to limit the present disclosure, application, or uses.

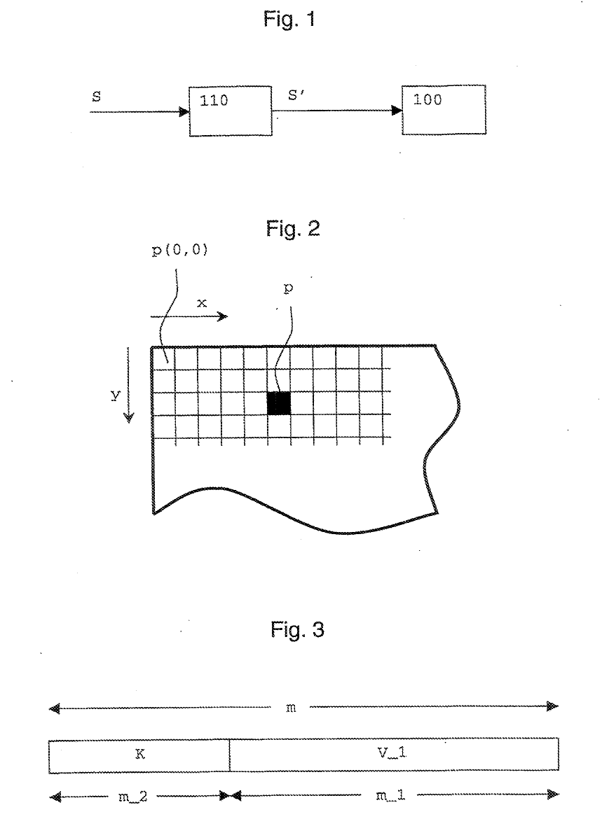

FIG. 1 shows the device 110 according to the disclosure for correcting an activation signal S for a display device 100 configured as a plasma screen, which has a multitude of picture elements affected by wear, which are preferably arranged in matrix form.

FIG. 2 shows such, for example, a picture element p of the plasma screen 100 of FIG. 1. Because of their matrix arrangement, different picture elements of the plasma screen 100 can be addressed, for example, by means of the coordinates x, y arranged in FIG. 2, that is, in the form of p(x,y), whereby the picture element arranged above left in FIG. 2 is allocated by definition, for example, to the coordinate values x=y=0, that is, p(x=0,y=0) or abbreviated p(0,0).

In this case, a monochromatic plasma screen 100 is assumed for reasons of clarity, that is, each picture element p(x,y) corresponds exactly to a pixel of the plasma screen 100. However, it is easily conceivable to also apply the process according to the disclosure on true color plasma screens, in which each pixel is comprised, as is known, by several, for example three picture elements, of which each corresponds, for example, to one of the basic colors red, green, or blue, so that a resulting color of the pixel consisting thereof is obtained by way of the additive color mixture of these basic colors. As the only difference with respect to the monochromatic plasma screen 100, the process according to the disclosure with a true color plasma screen is to be individually applied on each picture element that corresponds to the basic color of a pixel.

As can be seen in FIG. 1, the device 110 according to the disclosure receives as input signal a control signal S, which is comprised of chronologically consecutive activation signal values S(n), which are respectively allocated to one picture element p(x,y) of the plasma screen 100. Starting from a screen resolution of, for example, 1360 picture elements in the x-direction (refer to FIG. 2) and, for example, 765 picture elements in y-direction, a total of 1360*765=1040400 activation signal values are required, in order to activate each picture element p(x,y) of the plasma screen 100 once, that is, in order to form a complete picture of the plasma screen 100.

A frequency of 60 Hz is considered to be the established refresh rate in plasma screens, that is, 1360*765*60 activation signal values are fed every second to the device 110. With a true color plasma screen, in which a corresponding activation signal, for example, has three color channels instead of one, the triple amount of activation signal values is accordingly processed each second.

The device 110 according to the disclosure determines a wear value V for each picture element p(x,y) of the plasma screen 100 as a measure of the individual wear of the picture element p(x,y). The wear of a picture element p(x,y) is dependent, for example, on a period of operation of the considered picture element p(x,y) and on the activation signal values, with which it has been actuated during its period of operation. This wear acts in the manner of a deterioration of an electrical/optical conversion efficiency of the illuminant of the picture elements p(x,y) containing phosphorous compounds, so that a highly worn picture element has a lesser brightness than a less worn picture element which is activated with the same activation signal.

A correction value K can be determined based on the wear value (likewise for each picture element p(x,y) individually) using the process according to the disclosure, by means of which the control signal S can be corrected, in order to achieve a defined brightness especially in highly worn picture elements with a specific activation signal value.

The correction value K is used by the device 110 according to the disclosure to determine a corrected activation signal S′, which takes into consideration the respective degree of wear of the individual picture elements p(x,y), and thus makes possible the output of the picture corresponding to the activation signal S on the plasma screen 100 despite the described wear effect. This means, that the wear effects of each individual picture element p(x,y) are taken into consideration and the corrected activation signal S′ is formed as compensation from the activation signal S.

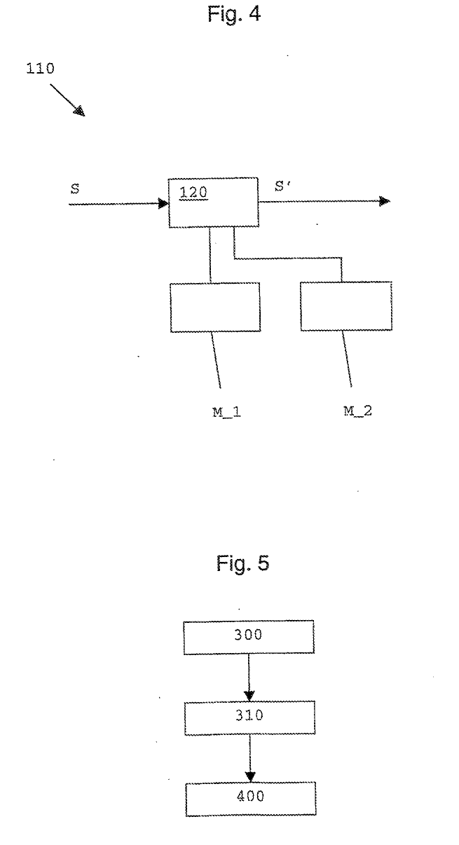

In order to determine the wear value V as well as form the correction value K and the corrected activation signal S′, the device 110 according to the disclosure of FIG. 1 has a computer unit 120 shown in FIG. 4, which can be configured, for example, as a digital signal processor (DSP). The functionality of the computer unit 120 can also be realized by means of a programmable logic component (FPGA) or an ASIC and will be described in further detail below.

According to step 300 of the flow diagram of FIG. 5, the chronologically consecutive values S(n) of the control signal S allocated to the one picture element p(x,y)considered are first added, whereby the primary wear value V_1 is obtained.

Activation signal values allocated to chronologically consecutive different picture elements p(x,y) occur because of the sequential data transfer with the activation signal S.

A first activation signal value, for example, is allocated to the left upper picture element p(0,0) of the plasma screen 100; refer to FIG. 2. A second activation signal value is allocated to the picture element p(1,0) located to the right of the picture element p(0,0) arranged on the right in FIG. 2, et cetera. After a total of 1360*765 activation signal values for a first picture have been fed to the device 110 according to the picture frequency of 60 Hz after 1/60 seconds, a subsequent activation signal value is again allocated to the left upper picture element p(0,0) and represents at the same time the first pixel of the second picture.

The chronologically consecutive activation signal values corresponding to the considered picture element p(x,y) are identified accordingly with S(n), whereby the index n corresponds to the n-th picture of a frame rate represented by the activation signal S. This means that S(0) is the activation signal value with which a considered picture element p(x,y) is activated in a first picture n=0, and S(1) is the activation signal value with which the same considered picture element p(x,y) is activated in a second picture n=1, which follows the first picture, et cetera.

With the assumed picture frequency of 60 Hz, a total of sixty activation signal values S(n) per second and picture element p(x,y) are to be added in the step 300 of the addition according to the disclosure, FIG. 5. The wear value V_1 obtained in this way is stored in a primary memory M_1, which is indicated in FIG. 5 by the step 310. The addition and storage, which will be explained below, is preferably carried out in real time, that is, essentially with the same data rate with which the activation signal values S(n) occur at the input of the device 110 (FIG. 1).

The primary memory M_1 is depicted in FIG. 4 and is connected via a suitable bus connection to the computer unit 120. The primary memory M_1 is preferably configured as a volatile memory, especially as an SDRAM memory, and thus supports in comparison with non-volatile memories almost any desired number of writing and reading accesses, which is required due to the extremely high data rate of the activation signal. In addition, the memory bandwidth made available today by the SDRAM memory components is sufficiently large to allow a real time processing of the activation signal values and their periodic storage in the form of the primary wear value V_1.

Aside from the storage of the primary wear value V_1 in the primary memory M_1 in the step 310 according to the disclosure, the primary wear value V_1 is at least partially transferred into a secondary memory M_2 in the step 400 of FIG. 5, which is likewise shown in FIG. 4, and preferably has its own bus connection to the computer unit 120. The secondary memory M_2 is preferably configured as a non-volatile memory, especially as a flash memory.

In this way, the secondary memory M_2 makes possible storage of the data stored therein also while the device 110 according to the disclosure is deactivated or is separated from the power supply.

The transfer according to the disclosure in the manner of the step 400 of FIG. 5 is carried out in such a way, that a predetermined transfer value UE is subtracted from the primary wear value V_1, that is, V_1=V_1−UE. The transfer value UE is then added to a secondary wear value V_2, which may eventually be present in the secondary memory M_2, that is, V_2=V_2+UE. If the transfer according to the disclosure takes place for the first time, no data has been stored until now in the memory M_2, and the memory cells of the secondary memory M_1 are initialized, for example, with the value zero.

By means of the transfer process described above, it is prevented, that the primary wear value V_1, which is stored in the primary memory M_1 and grows constantly as a result of the activation signal values arriving at the picture frequency of 60 Hz, exceeds a maximum allowed value range for the primary wear value V_1 because of the organization of the primary memory M_1.

In this example, a memory cell with m=32 bits is provided for each primary wear element p(x,y) in the primary memory M_1, refer to FIG. 3. According to the disclosure, of the m=32 bits of the memory cell only m_1=23 bits are provided for the storage of the primary wear value V_1. This means, that the value range for the primary wear value V_1 to be stored in the memory cell is between 0 and 2̂23−1=8388607. The residual m_2=m−m_1 bits of the memory cell of FIG. 3 are provided for the storage of the previously mentioned correction value K.

Even though the correction value and its processing will be described later in detail, it was already indicated here, that the simultaneous storage of the primary wear value V_1 according to the disclosure and the correction value K in the same memory cell of the primary memory M_1 has special advantages. One of these advantages consists in that with only one single memory access, which is, for example, both values, i.e., the primary wear value V_1 and the corresponding correction value K, can be accessed within one reading cycle of the primary memory M_1. In conventional systems, in which the correction value is recorded in a separate memory cell or even in another memory element, two separate memory accesses and/or one separate bus interface are required, in order to read a wear value and a correction value, which doubles the required access time or increases the expenditure for the circuit technology.

The primary wear value V_1 is preferably recorded according to the disclosure in the high value bits m_1 of the memory cell (FIG. 3), while the correction value K is recorded in the low value bits m_2 of the memory cell. A separation of the primary wear value V_1 from the correction value K, for example, after a reading of the memory cell is possible in a conventional way or using the predetermined bit masks.

The primary wear value V_1 increases to a maximum value of (2̂8−1)*60=15300 per second with a resolution of the activation signal values S(n) of respectively 8 bits to be added according to the step 300 of FIG. 5. The activation signal values S(n) at m_1=23 bits (FIG. 3) can thus be added over a period of about 548 seconds before the primary wear value V_1 exceeds its maximum allowed value. Within these 548 seconds, the transfer according to the disclosure of the step 400 (FIG. 5) from the primary memory M_1 into the secondary memory M_2 should therefore be undertaken.

A further embodiment of the process according to the disclosure provides, that the chronologically consecutive values of the corrected activation signal S′ allocated to the picture element p(x,y) are added during the step 300 of the addition. Since the activation signal S according to the disclosure is corrected and the display device 100 is accordingly operated altogether with a corrected activation signal S′, a precise determination of the actual wear of the display device 100 is possible.

During the transfer 400, only one predetermined number of high value bits is advantageously transferred from the primary wear value V_1 into the secondary memory M_2. In this way there results, on the one hand, a sufficient reduction of the primary wear value V_1, so that after the transfer the addition according to the step 300 can be carried out again for a specific time without the primary wear value V_1 exceeding the maximum wear value. On the other hand, the low value bits of the primary wear value V_1 are not deleted from the memory cell in the primary memory M_1, so that no accuracy loss is produced in the primary wear value V_1 and the following additions according to step 300.

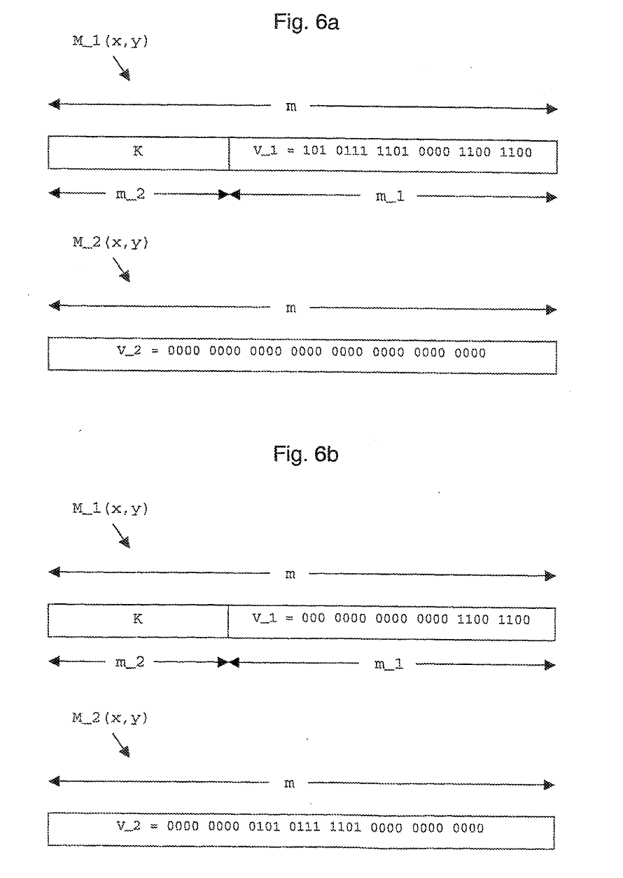

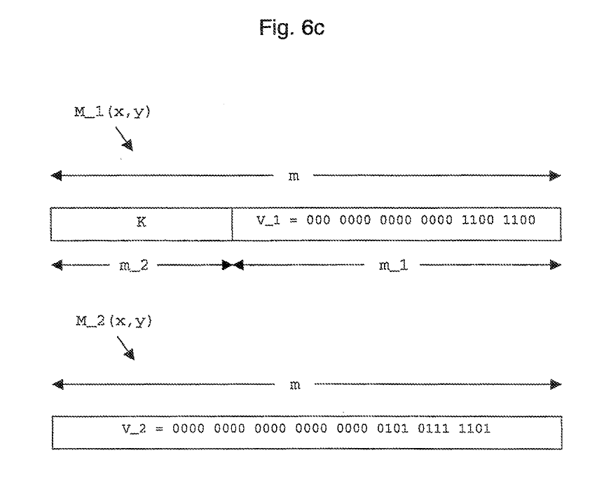

In order to represent the transfer according to the disclosure, a memory cell M_1 (x,y) of the primary memory M_1 allocated to the considered picture element p(x,y) as well as a corresponding memory cell M_2(x,y) of the secondary memory M_2 are depicted in FIGS. 6a and 6b. FIG. 6a indicates hereby the status or content of the memory cells M_1 (x,y), M_2(x,y) before the transfer, while FIG. 6b indicates the status or content of the memory cells M_1 (x,y), M_2(x,y) after the transfer.

As can be seen in FIG. 6a, the primary wear value V_1 before the transfer has the value “101 0111 1101 0000 1100 1100”. The primary wear value V_1 is then reduced by a predetermined transfer value UE, that is, V_1=V_1−UE, so that the value “1100 1100” results after the transfer for the primary wear value V_1 (refer to FIG. 6b). This means that the transfer value UE is selected in such a way, that it corresponds to the transferred high-value eleven bits of the primary wear value V_1. In the example, the transfer value is thus “101 0111 1101 0000 0000 0000”.

Since the secondary wear value V_2 has an initialization value of zero (FIG. 6a) before the described transfer procedure, its value corresponds to the transfer value UE, that is, “101 0111 1101 0000 0000 0000”, V_2=V_2+UE, after the transfer.

A further advantage of the transfer into the secondary memory M_2 consists the secondary wear value V_2 recorded once in the secondary memory M_2 also being retained in the case of a blackout or generally with a deactivation of the device 110 (FIG. 1), so that nearly complete data concerning the wear of the picture elements p(x,y) can still be available. In addition, the number of memory accesses of the secondary memory M_2 is relatively low, because in contrast to the primary memory M_1, for example, the secondary memory M_2 must be accessed in writing only approximately every 500 seconds for the transfer according to the disclosure in the step 400 of FIG. 5. In this way, it is ensured that a sufficiently high service life of the secondary memory M_2 is achieved.

The correction value K is recorded according to the disclosure only in the primary memory M_1, so that the memory cell M_2(x,y) provided in the secondary memory M_2 has all m=32 bits available for the representation of the secondary wear value V_2. In this way there results a value range of 0 to 2̂32−1 for the secondary wear value, that is, the secondary wear value V_2 can assume clearly greater values than the primary wear value V_1.

Before the deactivation of the device 110 according to the disclosure, not only one part of the primary wear value V_1, but the total primary wear value V_1, is transferred from the primary memory M_1 into the secondary memory M_2. In this way, also the low-value bits of the primary wear value V_1, which are normally not transferred during operation into the secondary non-volatile wear value V_1, are secured, whereby in this case also the secondary wear value V_2 recorded in the secondary memory M_2 has a maximum possible precision. The correction value K can then be calculated with a renewed activation of the device 110, for example, based on this secondary wear value V_2.

In a further advantageous embodiment of the disclosure, it is provided, that the at least a partial transfer of the primary wear value V_1 is divided by a predetermined divisor value in step 400, in order to obtain a reduced transfer value, and the reduced transfer value is added to the secondary wear value V_2 stored in the secondary memory M_2.

This means that even though the transfer value is subtracted from the primary wear value V_1, at the same time now the reduced transfer value is added to the secondary wear value stored in the secondary memory. In this way two advantages are attained: the addition or storage of the primary wear values in the primary memory is carried out as always with a maximum accuracy, because the low-value bits of the primary wear values in each addition are also taken into consideration. On the other hand, a value is added with the reduced transfer value to the secondary wear value, which is smaller than the transfer value that is subtracted from the primary wear value, so that the secondary wear value grows on average less fast than the primary wear value.

The previously described process variation can be seen in FIGS. 6a and 6c. Starting from the status of the memory cells M_1 (x,y) and M_2(x,y) before the transfer shown in FIG. 6a, the value “101 0111 1101 0000 0000 0000” is selected as transfer value UE similarly as in FIG. 6b. Before the addition, this transfer value UE is divided, however, by a divisor value of, for example, 2̂12, which corresponds to twelve binary positions. This means that the value (101 0111 1101 0000 0000 0000)/(2̂12)=101 0111 1101 is obtained as reduced transfer value after the addition. This reduced transfer value is then added to the secondary wear value V_2, from which results the content of the memory cell M_2(x,y) that can be seen in FIG. 6c.

The accuracy loss, which results from the transfer of the transfer value “101 0111 1101 0000 0000 0000” to the reduced transfer value “101 0111 1101”, is negligible therein. In contrast to the usual process, the accuracy loss caused by the use of the reduced transfer value can occur only in step 400 of the transfer, which is carried out relatively rarely in comparison with the steps 300, 310 (FIG. 5). Since the twelve low-value bits, which are not taken into account during the transfer, but still remain stored in the primary memory M_1 as low-value bits of the primary wear value V_1, the addressed accuracy loss can only then occur with the process according to the disclosure, when the display device 100 is deactivated and also no security of these low-value bits is provided for the case of a deactivation.

Starting from the numerical example described above, a transfer according to step 400 of FIG. 5 is carried out at the latest approx. every 548 seconds in the process according to the disclosure, i.e., the accuracy loss of the available 12 bits introduced by the reduced transfer value can also only occur every 548 seconds with a considered secondary wear value V_2 (FIG. 6c), insofar as the display device is deactivated directly after the transfer.

In contrast to this, when adding or storing a value comparable to the primary wear value V_1 in the customary process, usually one part of the value to be stored, for example, the six low-value bits of the value, is not considered or is discarded. This means, that a 6-bit portion of the value to be added is not taken into consideration sixty times per second according to the picture frequency of 60 Hz in the state of the art, which brings with it a considerably higher accuracy loss in comparison with the process according to the disclosure according to FIG. 6c, since the uncertainty of an added value increases by a value of 60*(2̂6−1)=3780 for each second. In 548 seconds, this error adds up to a maximum of 548*3780=2071440, while the maximum error with the process according to the disclosure—also only in the unlikely case of a regular deactivation of the display device always after the transfer—has a value of 2̂12−1=4095 for each 548 seconds, that is, by a factor of about 500 less than in the state of the art. The accuracy loss of 4095 for each 548 seconds that adjusts the process according to the disclosure corresponds, for example, to the non-consideration of the activation signal values of approx. only sixteen pictures for each 548 seconds and is thus negligible.

A power of two is used as divisor value in the process according to the disclosure in an especially practical manner, so that the reduced transfer value can in particular be efficiently determined. In general, it is also conceivable to obtain the reduced transfer value by means of another calculation specification from the transfer value.

In a variation of the process which uses the reduced transfer value and thus does not take into consideration, for example, the twelve low-value bits of the primary wear value V_1 or adds these to the secondary wear value, these twelve low-value bits are accordingly also not to be directly transferred into the secondary memory before a deactivation of the device 110.

In a process variation such as this, a maximum value of 2̂11−1 is added to the secondary wear value V_2 with each step 400 of the transfer, that is, for example, about every 548 seconds, to the secondary wear value V_2 according to the transferred eleven high-value bits of the primary wear value V_1 which are to be transferred. Starting from a value range of m=32 bits (refer to FIG. 6c), the secondary wear value V_2 can be incremented starting from its initialization value of zero, that is, approximately (2̂32)/(2̂11)=2̂21 times by the maximum value of 2̂11−1. With the maximum allowed waiting time of 548 seconds there is obtained a maximum time of about 319000 hours, via which the secondary wear value V_2 can be stored for this purpose in the memory cell M_2(x,y) of the secondary memory M_2.

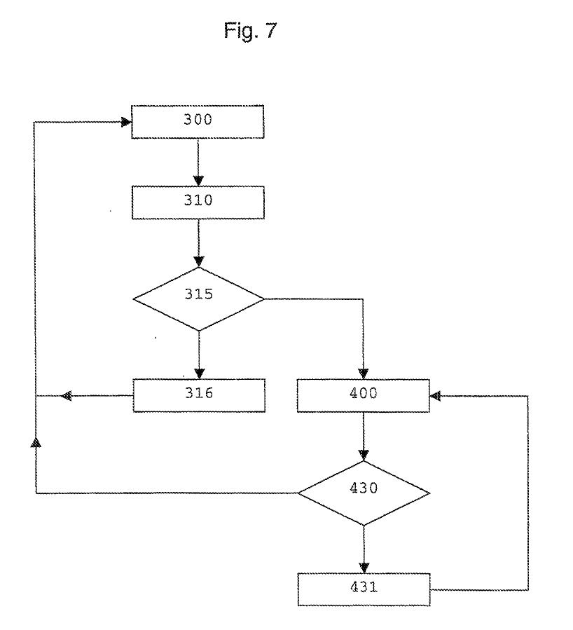

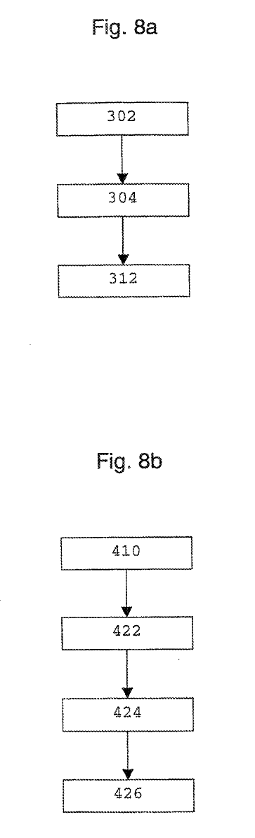

While the principle according to the disclosure of storing the wear value in the form of the primary wear value V_1 in the volatile primary memory M_1 and in the form of the secondary wear value V_2 in the non-volatile memory M_2 has been described based on a single considered picture element p(x,y), is it described in the following with reference to the FIG. 7 and the FIGS. 8a and 8b, which disclose further details of the process, in what way the wear values of further picture elements p(x,y) of the plasma screen 100 are processed.

As already described, a currently available activation signal value S(n) or a corrected activation signal value S′(n) is first added for a first considered picture element p(x,y) in step 300 of FIG. 7 to a primary wear value V_1 of the considered picture element p(x,y), which is eventually already present in the corresponding memory cell, and the sum obtained therefrom is stored in step 310.

For this reason, in step 302 according to FIG. 8a, which shows in further detail the steps 300 and 310 of FIG. 7, the previous primary wear value V_1_old, which is already stored in the primary memory M_1, is first read out and is then added in step 304 to the current available activation signal value S(n) or to the corrected activation signal value S′(n), whereby a current primary wear value V_1_new=V_1_old+S(n) is obtained, which is finally stored in step 312 as primary wear value V_1 in the corresponding memory cell of the primary memory M_1, whereby at the same time the previous primary wear value V_1_old, which was previously stored in the primary memory M_1, is overwritten. Instead of the activation signal value S(n), an already corrected activation signal value S′(n) is preferably used, as already mentioned, for the addition 304.

After this update of the primary wear value V_1 of the first considered picture element p(x,y), an inquiry is made according to FIG. 7 in step 315, whether the primary wear value V_1 of a next picture element p(x+1,y) is to be updated in the same way.

If this is the case, in step 316 of FIG. 7, the next picture element p(x+1,y) is selected and the already described update for the next picture element p(x+1,y) is then carried out.

As an alternative, the inquiry of step 315 can also be branched off toward step 400, in order to carry out the transfer according to the disclosure of at least one part of the primary wear value V_1 of a considered picture element p(x,y) into the secondary wear value V_2, and therefore also into the secondary memory M_2.

The procedure details of the transfer 400 are shown in FIG. 8b. As was already described, at the start of the transfer the primary wear value V_1 to be transferred is reduced in step 410 by the predetermined transfer value UE. In addition, in step 422, a previous secondary wear value V_2_old, which is eventually already stored in the secondary memory M_2, is read out from the corresponding memory cell of the secondary memory M_2, and the transfer value UE is added to the previous secondary wear value V_2_old is added in step 424, which is finally stored in step 426 as secondary wear value V_2 in the corresponding memory cell of the secondary memory M_2, whereby at the same the previous secondary wear value V_2_old, which was previously stored in the secondary memory M_2, is overwritten.

An inquiry with regard to if the secondary wear value V_2 of a next picture element p(x+1,y) is to be updated in the same way as with the transfer 400 is carried out according to FIG. 7 in step 430 after this update of the secondary wear value V_2 of the first considered picture element p(x,y) through the step 400 of the transfer.

If this is the case, in the step 431 of FIG. 7, the next picture element p(x+1,y) is selected and the already described update or the transfer 400 for this next picture element p(x+1,y) is then carried out.

As an alternative, the inquiry of step 430 can also branch off to step 300, in order to again update a primary wear value V_1 of a picture element p(x,y) in the already described way.

The steps 300 to 316 disclosed in FIG. 7 can be considered as a first working cycle, in which the processing of the arriving activation signal values S(n) is carried out essentially in real time, that is, approximately with a data rate with which the activation signal values S(n) meet with the device 110 (FIG. 1).

A second separate working cycle is provided by means of the steps 400 to 431, with which primary wear values V_1 are at least partially transferred into the secondary memory M_2, in order to permanently record therein the determined wear values and in order to at least partially “empty” the memory cells M_1(x,y) (FIG. 6a, 6b) of the primary wear values V_1, so that further occurring activation values S(n) can be added there without exceeding the maximum value range for the primary wear values V_1.

The second working cycle can be repeated for the considered memory cells of the primary memory M_1, for example, with a period duration of 400 seconds. This means that a primary wear value V_1 of the considered picture element p(x,y) is transferred approximately every 400 seconds into the secondary memory. Accordingly, the second working cycle runs at a different time and asynchronously with respect to the first working cycle. The second working cycle must also not run in real time; the arithmetic operations or other processing steps required to carry out the second working cycle also occur with a low processing speed.

The correction value corresponding to a wear value of a picture element p(x,y) is finally calculated in a third working cycle, which was not described until now, in order to compensate therewith for the corresponding activation signal S. This third working cycle is preferably carried out at the same time, that is, synchronously with the second working cycle, because the current secondary wear value V_2 is available in a working memory of the computer unit 120 (FIG. 4) for transfer according to the disclosure in step 400 of FIG. 7, and must thus not be separately read in once more at a later time.

As an alternative to this, it is also possible to carry out the calculation of the correction value at a different time than the second cycle and asynchronously with respect to it.

In a further advantageous embodiment of the disclosure, a programmable logic component, a so-called FPGA (Field Programmable Gate Array) is used, in order to make available the functionality of the computer unit 120 (FIG. 4).

The FPGA 120 is configured therein in such a way that it comprises different logic units (not shown), which can respectively carry out per se any processing steps of the method according to the disclosure.

The FPGA 120 has, among other things, a primary logic unit, which should be configured in such a way, that it carry out the steps 300, 310 of FIG. 5 according to the disclosure in a fully independent manner. This means that the primary logic unit adds the chronologically consecutive values S(n) of the activation signal S or the corrected activation signal S′ allocated to a picture element p(x,y), in order to obtain the primary wear value V_1, and the primary logic unit stores then the primary wear value V_1 in the primary memory M_1. The implementation of these steps is carried out through the primary logic unit with a data rate that corresponds to the data rate of the activating signal S, i.e., there is no need to intermediately store any of the activation signal values. The address generation for the intervention of the primary memory M_1 is likewise carried out in the primary logic unit. The first working cycle is entirely carried by the primary logic unit as a whole with the steps 300, 310.

From a CPU, which is likewise realized in the FPGA 120, the primary logic unit preferably receives a periodic target memory address. This target memory address is the memory address at which a primary wear value V_1 of a picture element selected by the CPU to carry out the step 400 (FIG. 5) is stored.

The primary logic unit determines in each of the activation signal values S(n) processed by it, if a memory address of the primary memory M_1, which is actually used in the step 310 of the storage, coincides with the target memory address predetermined by the CPU. If this is the case, the primary logic unit perceives, that the CPU will carry out the transfer according to the disclosure following step 400 with the primary wear value V_1 stored at the target memory address. Accordingly, the primary logic unit carries out all the necessary steps for the transfer 400. This means, that it reduces the primary wear value V_1, which is to be stored by it, by the transfer value UE within the scope of the steps 310 before the storage and transfers the latter to the CPU, so that the CPU can write the corresponding memory cell of the secondary memory M_2.

This transfer can be advantageously carried out, for example, by means of an intermediate storage of the transfer value UE in a register of the FPGA 120, in order to obtain a chronological decoupling of the CPU from the primary logic unit. The primary logic unit furthermore stores at the same time with the new primary wear value V_1 a correction value K, which is likewise obtained from the CPU and belongs to the primary wear value V_1, in the corresponding memory cell of the primary memory M_1.

After the primary logic unit has carried out all the work steps that it must carry out, in order to implement the transfer 400, an interrupt is triggered, which signalizes to the CPU, that the primary logic unit has completed the transfer 400 to the target memory address which was previously predetermined by the CPU. The CPU then predetermines a next target memory address for the primary logic unit and again makes possible the triggering of an interrupt by means of the primary logic unit.

Due to the autonomy of the primary logic unit with regard to the processing of the steps 300 and 310, the CPU can carry out further processing steps, such as, for example, the second working cycle, parallel to the first working cycle by the primary logic unit; refer to step 400 of FIG. 5. In this way, the CPU can reduce, for example, a transfer value obtained from the primary logic unit and can then store said value in the secondary memory M_2 or it can also, for example, determine a correction value K from the secondary wear value V_2 of the target memory address predetermined thereby, in order to make it available to the primary logic unit.

While there is no interaction of the CPU with the primary logic unit, for example, for the processing of an interrupted triggered by it, the CPU can also carry out any other desired steps of the process according to the disclosure.

The selection of one of the target memory addresses predetermined by primary logic unit can take place, for example, in such a way, that the CPU increments a corresponding address counter by one predetermined value. For example, the value of the target memory address can be incremented by a value of 4000, i.e., after the processing of a target memory address, whose picture elements are allocated to the current activation signal value, a memory address is provided as next target memory address, which corresponds to a picture element that is at a distance of 4000 address signal values in the activation signal. By means of a selection of the incremental value such as this, the CPU remains for a time that is sufficient to carry out, if required, any desired interventions on the secondary memory M_2 or other work steps before that activation signal appears which corresponds to the new target memory address.

If the CPU of the primary logic unit predetermines a target memory address, whose corresponding activation signal has appeared, for example, shortly before in a currently processed picture, and has been processed with the steps 300 and 310 by the primary logic unit without the actually provided address comparison having taken place, the primary logic unit can first carry out a positive address comparison in the subsequent picture or the corresponding activation signal values, and can carry out the step of the transfer 400 in a corresponding picture element.

In general, the incremental value for the target memory address of the CPU should be selected in such a way, that the step 400 of the transfer can be periodically carried out for each picture element. In accordance with the above-described numerical example, each target memory address must therefore be processed at least once every 548 seconds.

Instead of the CPU configured in the FPGA 120, further logic units can also be configured in the FPGA, which can take over the work steps of the CPU. In this case, it is not mandatory to configure a CPU within the FPGA 120.

In general, a realization of the disclosure by means of an ASIC is also conceivable, which takes over the task of the computer unit 120 as well as, in addition, the primary memory M_1 and/or the secondary memory M_2, or other components.

Generally, the correction value K according to the disclosure, which is required for the correction of the activation signal S, is determined using a characteristic line or a characteristic field, which is applied as an input variable, among other things, on the secondary value V_2.

The characteristic line or the characteristic field can indicate hereby a connection between a wear of the picture elements p(x,y) of the plasma screen 100, which is represented by the secondary wear values V_2, and the correction value, with which the activation signal S (FIG. 1) is to be corrected, in order to make possible a wear-adjusted display of a picture on the plasma screen 100 by means of the corrected activation signal S′.

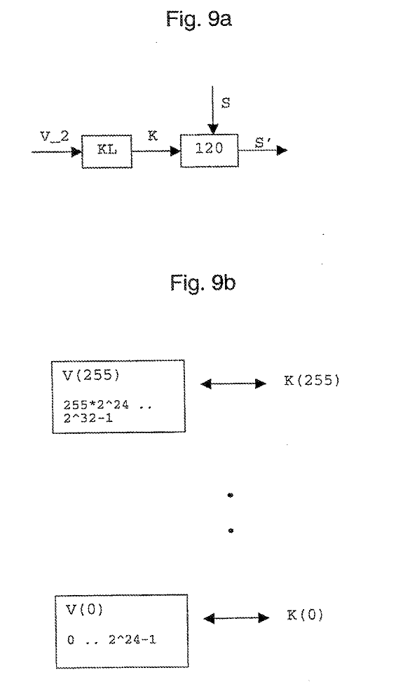

FIG. 9a represents the calculation of a correction value K by means of a characteristic line KL as well as the additional determination of the corrected activation signal S′ simplified by means of the computer unit 120. A calculation such as this is carried out according to the disclosure for each picture element p(x,y) of the plasma screen 100, so that a correction which is individual to each picture element of the respective activation signal S is possible.

Depending on the type of correction value, the correction value K for correcting the activation signal S can be additively or only multiplicatively linked to the activation signal S. In an embodiment of the disclosure, the characteristic line KL allocates a wear value interval to each possible correction value, which has at least one wear value. In this way, a correction value K that is allocated to the secondary wear value V_2 (FIG. 9a) can be determined by determining the wear value interval in which the considered secondary wear value V_2 is located.

8 bits are provided, for example, in order to represent a correction value, so that a total of 256 different correction values K(i), i=0, . . . , 255 is possible. One of a total of 256 wear value intervals V(i) according to the disclosure is allocated to each of these 256 different correction values K(i); refer to FIG. 9b.

The first wear value interval V(0) comprises therein wear values from 0 . . . 2̂24−1, and the latest wear value interval V(255) comprises wear value of 255*2̂24 . . . 2̂32−1. The wear value intervals V(1) to V(254) are not shown in FIG. 9b.

The wear interval value V(i), in which the secondary wear value V_2 is located, can be determined, for example, within the scope of a linear search starting from the secondary wear value V_2 (FIG. 9a), for which a matching correction value K(i) is to be determined by reason of their above-mentioned definition based on the knowledge of the limits of the wear value interval V(i). A correction value K(i), which is allocated to this secondary wear value V_2, should be used for the secondary wear value V_2.

The wear value interval V(i), in which the secondary wear value V_2 is located, can be advantageously determined by means of a binary search of the wear value intervals V(i), whereby a lower expense occurs, just like in the previously described linear search. For this purpose, the known secondary wear value V_2 is checked, for example, to determine, if it is contained within an average wear value interval V(127). Based on a wear result such as this, only one half V(0), . . . , V(126) or V(128), . . . , V(255) of the wear value intervals V(i) is to be checked, which can be carried out, for example, in the way of the recursion and requires a maximum of eight search steps with 256 different correction values K(i).

A further advantage of the wear value classes V(i) according to the disclosure consists of only one search within a solution space having 8 bits being required, in order to find a correction value K(i) that matches the secondary wear value V_2 having 32 bits, so that neither 2̂32 different characteristic line values must be present or stored nor more than 2̂8 search operations are required.

As soon as the correction value K(i) has been determined, it can be recorded, for example, in the m_2 bits (FIG. 3) of the memory cell provided for this purpose in the primary memory M_1, which contains at the same time the primary wear value V_1 belonging to the secondary wear value V_2 (FIG. 9a).

In addition, the correction value K(i) is read out, for example, in the next step of the addition 300 (refer to FIG. 7) of the corresponding picture element p(x,y), together with the primary wear value V_1, in order to correct the activation signal S (FIG. 1) and thus obtain a corrected activation signal S′ for the considered picture element p(x,y). The reading out of the correction value (K(i)) and the determination of the corrected activation signal S′ is preferably carried out in real time, just like in the step 300 of the addition (FIG. 7), et cetera, in order to be able to carry out a corresponding operation for each picture element p(x,y). 300 activation signals S′(n) of the corrected activation signal S′ are preferably added during the addition 300.

The correction values are determined for all the picture elements p(x,y) of the plasma screen 100 (FIG. 1) in a similar manner just as in the aforementioned process and are preferably determined together with the secondary cycle of the transfer (refer to step 400 of FIG. 7), so that a corresponding correction value is available in addition to the activation of each picture element p(x,y).

The correction values of the picture elements p(x,y) are not stored in the secondary memory M_2 according to the disclosure, so that a maximum value range can be selected, which is available for storing the secondary wear values V_2. In addition, during the activation of the device 110 (FIG. 1) according to the disclosure, it is possible to easily read in the secondary wear values V_2 by means of the computer unit 120 (FIG. 4) from the secondary memory M_2 and to determine the corresponding correction values (K(i)) therefrom and to store these in the primary memory M_1.

During this activity phase, the activation signal S is advantageously not processed by the computer unit 120, so that the entire computation power of the computer unit 120 can be used for the initial determination of the correction value (K(i)), and this process is thus accelerated.

It is also possible to process the activation signal S by means of the computer unit 120 during the activation phase, especially in order to determine the current primary wear values V_1, and calculate parallel thereto the correction curve (K(i)). As long as the correction values (K(i)) in this process variation have not yet been determined, the plasma screen 100 or its picture element p(x,y) can be directly activated with the uncorrected activation signal S.

As an alternative, it is possible to store the correction values in the non-volatile memory M_2, in order to avoid having to calculate them anew during a new activation of the device 110.

The correction values are herein preferably recorded in a separate area of the non-volatile secondary memory M_2, i.e., not in the memory cells M_2(x,y) provided for accommodating the secondary wear value V_2, in order to prevent affecting a maximum possible value range of the secondary values V_2.

In a further variation of the disclosure, which provides for a non-volatile storage of the correction values, it is proposed to transfer the correction value K together with the primary wear value V_1 into the secondary memory M_2.

In a further embodiment of the disclosure, a program code and/or configuration data, for example, of a volatile configurable FPGA is likewise stored in the secondary memory M_2, in order to control the computer unit 120 (FIG. 4) aside from the non-volatile storage of the secondary wear values V_2 and, if required, the correction values in the secondary memory M_2. A special area of the secondary memory M_2 is reserved for this purpose, if required, which is not used for storing the secondary wear values V_2. It is also possible to at least transfer one part of the program code provided for the computer unit 120 during an operation of the device 110 or the computer unit 120 into the usually faster primary memory M_1.

In a further disclosure variation, the correction value K has a value range of [0, . . . , 127] in a binary representation and can thus not be represented by means of 7 bits. The correction value K is hereby provided for the multiplicative linkage to an activation signal value having 8 bits. A numeric value of 129 is added to the correction value K before the multiplication, in order to transform its value range from [0, . . . , 127] to [129, . . . , 256]. A multiplication of the transformed correction value is then carried out with the activation signal value, and the eight low-value bits of the products resulting from the multiplication are cut off, in order to obtain a corrected activation signal value, which has, in turn, a value of [0, . . . , 255].

Able to be used as an activation signal S in general is also an RGB signal, for example, which is emitted by a graphic card of a computer and has also three color channels. In contrast to a monochrome system, the work steps according to the disclosure must be carried out herein for each activation signal value of each color channel R, G, B, whereby the processing of a color channel R, G, B is likewise carried out just as in the processing of the monochrome activation signal, which was described in detail above.

When the RGB signal is used as activation signal, it accordingly requires three times the number of memory cells in the primary memory M_1 and the secondary memory M_2, and since three activation signals corresponding to the three basic colors are simultaneously processed in the RGB signal, also a memory bandwidth of the primary memory M_1 which is three times higher is required under certain circumstances, as well as a correspondingly higher computation power of the computer unit 120.

In a further variation of the disclosure, a primary memory M_1 with a data bus width of 64 bits is advantageously provided, so that each storing or reading access can simultaneously access two memory cells with 32 bits each.

In order to further reduce the time and effort in connection with the memory accesses on the primary memory M_1, the reading and writing operations on the primary memory M_1 have the form of a so-called burst access, in which a corresponding memory address must be indicated respectively only once via the address lines of the primary memory M_1, and in which in addition a multitude of memory cells can be read or written.

In the first cycle according to the disclosure (refer to steps 300 and 310), the primary wear values V_1 are preferably read in or written by fifteen adjacent picture elements p(x,y) from the primary memory M_1. In this way, a memory number of the value fifteen is defined. These fifteen adjacent memory cells are comprised, for example, of five groups of three picture elements each, in which three picture elements of one group are allocated to the different basic colors R, G, B, respectively.

Since the mentioned burst accesses usually allow a successive reading or writing of their number according to a power of two on memory cells, that is, for example, the storage of sixteen memory cells, a total of sixteen memory cells are written in the burst access according to the disclosure. Of the sixteen written memory cells, fifteen correspond to the above-defined memory number, which has the corresponding primary wear values of the fifteen adjacent picture elements p(x,y). According to the disclosure the sixteenth memory cell contains a special bit pattern, which is verified with a reading out of the written memory cells, in order to check the reliability of the primary memory M_1.

In addition, the sixteenth memory cell can also contain a test sum concerning the fifteen memory cells, which corresponds to the memory number.

The device 110 of the disclosure is advantageously already integrated in the plasma screen 100 or a circuit arrangement existing therein. It is possible in this way to realize the functionality of the device 110 or the computer unit 120 as well as the memory M_1, M_2 according to the disclosure by means of components that are already present in the plasma screen 100, such as, for example, a DSP of a plasma screen controllers or a video memory of the plasma screen 1000, or the like.

As an alternative to this, it is possible to configure the device 110 according to the disclosure as a series connection unit, which is comparable to a plasma screen 100, having an input for the activation signal S and an output that can be connected to a conventional plasma screen, in order to actuate the same by means of the corrected activation signal S′ determined according to the disclosure.

In another variation, an RGB signal is not used as the activation signal S, which originates, for example, from the graphic card, but a pulse frequency is directly used, with which a plasma pulse generator actuates the individual picture elements p(x,y).

A pulse frequency such as this indicates (just like a conventional activation signal over its amplitude) with what level of brightness a corresponding picture element of the plasma screen is to be operated. This pulse frequency of plasma screens is usually calculated by a plasma display controller depending, for example, on an RGB signal that is fed to the plasma screen.

However, it can occur that the plasma display controller does convert the RGB signal exactly, i.e., 1:1, into a corresponding pulse frequency, but carries out algorithms, for example, for the gamma correction, a scaling of the picture resolution, and the like, so that a practical determination of the wear values is possible on the basis of the RGB signals fed to the plasma screen. For this reason, a determination of the wear values V_1, V_2 directly depending on the pulse frequency according to the disclosure is considered particularly advantageous. Instead of the activation values S(n), it is easier to add or store the pulse frequency fed to the considered picture elements p(x,y) in this case in the steps 300 and 310 (FIG. 7). The pulse frequency can herein be made directly available to the computer unit 120 according to the disclosure by the plasma display controller. As a corrected activation signal S′, the device 110 outputs in this case, if applicable, a corrected pulse frequency to the plasma screen 100.

The distribution of the memory cells M_1(x,y), M_2(x,y) of FIG. 6a, 6b can also be selected differently, depending on the resolution of the activation signal values or the pulse frequency or the favored time constants especially for the secondary cycle of the transfer (compare to step 400 of FIG. 7).

It is generally sufficient if the correction value has a resolution that is lower by one bit than an activation signal which is to be corrected therewith. The correction value can have, for example, a value range of 0.5 to 1.0, with the activation signal value in a multiplicative linkage to the activation signal which is to be corrected.

Especially in relatively high color depths or resolutions of the activation signal of, for example, 10 bits or 10 bits for each color channel, the lowest value bit or also several low value bits of the activation signal can be disregarded, in order to measure or form the primary wear value V_1, i.e., these negligible bits must not be recorded in the memory cell for the primary wear value V_1. The full resolution of the activation signal S, i. e., all 10 bits can be used, in order to determine the corrected activation signal.

In a further advantageous embodiment of the disclosure, the primary wear value V_1 and/or the secondary wear value V_2 and/or the correction value K is subjected to a differential encoding and/or an entropy encoding especially before the storage.

The entropy encoding is particularly suitable for the storage of secondary wear values V_2 and/or the correction values, because the corresponding second or third work cycle (refer to step 400 in FIG. 7) does not have to be carried out in real time and because in this way the memory demand on the secondary memory can be further reduced.

In another further embodiment of the process according to the disclosure, the secondary wear values V_2 are stored block-by-block within the scope of the transfer (refer to step 400 of FIG. 5), that is, a multitude of secondary wear values V_2 that are to be stored is determined before they can be written once in a single block in the secondary memory. Able to be used as secondary wear values V_2 to be stored block-by-block, there are, for example, the current secondary wear values V_2_new determined in step 424 of FIG. 8b. These current secondary wear values V_2_new are not recorded separately in the secondary memory M_2 in this variation of the disclosure, as already described in step 426 of FIG. 8b, but they are intermediately stored until a predetermined number of secondary wear values V_2 has been obtained, which are now recorded in a single block in the secondary memory M_2.

The block-by-block storage according to the disclosure contributes to the increase of the service life of the secondary memory M_2, because less writing accesses of the secondary memory M_2 are overall required. The mentioned intermediate storage of the predetermined number of secondary wear values V_2 up to the storage of a block can be carried out, for example, in a special area of the primary memory M_1 or also in a work memory that is separate therefrom (not shown) of the computer unit 120 (FIG. 4) or also in special register memories of the computer unit 120.

In the previously mentioned block-by-block storage, a block identification can also be stored in the block to be stored, which makes possible an allocation of the secondary wear values V_2 combined in the block to the picture elements p(x,y) allocated to them.

Particularly advantageous is also a block-by-block storage in the secondary memory M_2 according to the principle of a ring buffer, that is, blocks that are to be stored block-by-block one after the other are also recorded one after the other in an address space of the secondary memory M_2, and likewise cyclically overwritten as soon as the entire available memory space of the secondary memory M_2 has been filled with blocks, et cetera.

The ring buffering principle makes possible a finding of a specific block in the secondary memory M_2 due to the constant block length and the knowledge of the memory algorithm in principle, even when no information about it is available regarding at which address in the secondary memory M_2 the considered block has actually been stored.

As an alternative thereto, a table can also be provided, which allocates the secondary wear values V_2, that are combined into blocks, to the block identifications and/or the memory address of the respective block in the secondary memory M_2. A table such as this is preferably stored in the primary memory M_1 during an operation of the device 110 according to the disclosure, while a recording of the table in the non-volatile secondary memory M_2 is practical especially before the deactivation of the device 110 in order to keep available the data stored therein.

It is also possible to form a test sum over either several secondary wear values V_2 or over the entire block and to record these preferably together with the block in the secondary memory M_2.

In a further embodiment of the disclosure, a picture element p(x,y) of the plasma screen 100 is activated with a special activation signal (not shown), which triggers in a targeted manner an accelerated wear of the considered picture element p(x,y). Especially picture elements with above average low-wear values V_2 can be adapted in this way with regard to their electrical/optical conversion efficiency by means of this “artificial aging” to particularly highly worn picture elements, in order to achieve an equalization of a picture shown on the plasma screen 100.

A wear value averaged over all the picture elements p(x,y) of the plasma screen 100 can be determined, for example, in order to select the picture element that is to be subjected to the accelerated aging. For this reason, the secondary wear value V_2 is preferably used for this purpose. In addition, the individual picture elements or their individual wear values V_2 are respectively compared to the averaged wear value, and it is compared depending on this average wear value, if the considered picture element is to be subjected to the accelerated aging by actuating it with the special activation signal. The special activation signal is preferably an activation signal that activates the considered picture element with a maximum possible brightness, i.e., with a maximum activation signal value.

Instead of determining a wear value averaged over all the picture elements p(x,y) of the plasma screen 100 as a reference variable for the accelerated aging, only one group of picture elements can be taken into consideration, whose wear values V_2 exceed a predetermined threshold value. However, such a group should comprise clearly more than a single picture element, in order to prevent a multitude of picture elements from being subjected to an accelerated aging process under certain circumstances, in order to achieve the wear level of only one single particularly highly worn picture elements.

Instead of the wear value an especially determined correction value of the picture elements p(x,y) can also be considered, in order to determine which picture elements p(x,y) are to be subjected to an accelerated aging.

In a further embodiment of the process according to the disclosure, a weighting of the values S(n) to be added is carried out using the step of the addition 300 of the chronologically consecutive values S(n) of the activation signal S allocated to the picture element p(x,y) before the addition 300. Non-linear connections between the activation signal values S(n) and an actual wear of the considered picture element can be taken into account in this way.

By means of a weighting before the addition 300, further influences acting on the wear behavior, such as, for example, an ambient temperature and the like, can also be taken into consideration. Corresponding weighting factors can be obtained in a manner known per se from the characteristic lines or characteristic fields. In order to determine an ambient temperature or also the temperature of the plasma display 100, one or several temperature sensors (not shown) can be provided.

The previously described weighting can also be used, in order to reproduce a change of the activation signal in a RGB activation signal by means of the plasma display controller, so that the weighted activation signal values correspond to those of the activation signal values, which are received by the plasma display controller, for example, by means of the gamma correction or the like carried out by it. In this process variation, it is not necessary to use the pulse frequency as an activation signal emitted by the plasma display controller to the plasma screen 100, because the behavior of the plasma display controller can be simulated by means of the weight according to the disclosure.

In a further advantageous process variation, it is proposed to not use a predetermined number of low-value bits of the activation signal S, in order to determine the primary wear value V_1. In this way, the average chronological increase of the primary wear value V_1 is reduced, whereby greater intervals between two transfer steps 400 (FIG. 5) are produced, while the precision loss that accompanies this can be tolerated.

The process according to the disclosure is not limited to the application on plasma screens. It is also conceivable to apply the process in display devices, which have organic light emitting diodes (OLED), picture elements that work according to the field emission principle (FED), or other picture elements affected by wear. In principle, an application of the process according to the disclosure is also possible in CRT displays.

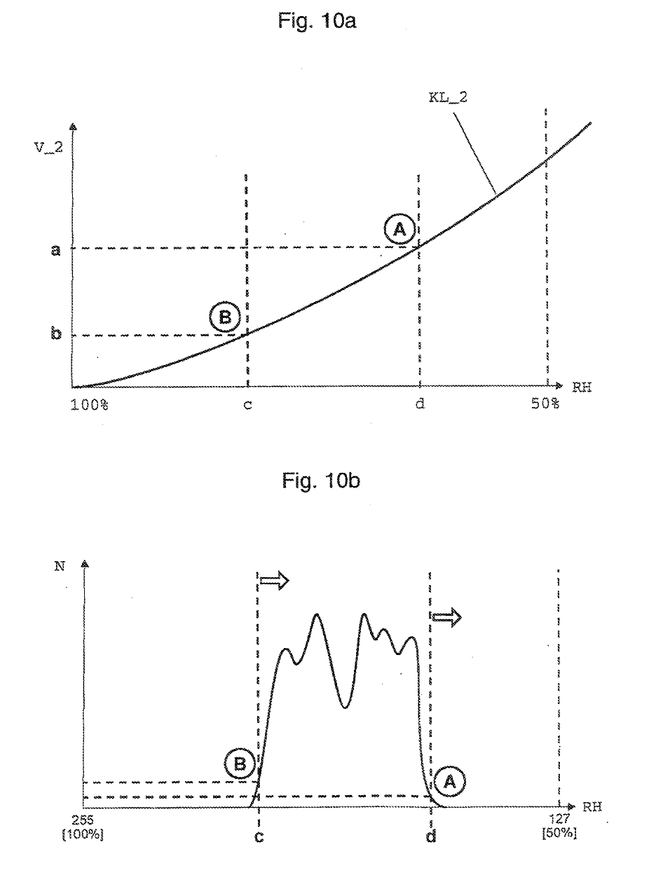

In still another embodiment of the process of the disclosure, the correction value K is determined depending on a characteristic line KL_2, which indicates a connection between the wear of a picture element, especially between the secondary wear value V_2, and a residual brightness RN with maximum activation of the picture element. A characteristic line KL_2 such as this is represented in FIG. 10a. The ordinate of the characteristic line KL_2 corresponds therein to the secondary wear value V_2, whose calculation has already been described in detail, and the abscissa indicates the residual brightness RH of a picture element with maximum activation.

The secondary wear value V_2 indicates a sum of the operation duration of a picture element of the plasma screen 100, which is weighted with the individual activation signal values S(n), based on its calculation. This variable can also be interpreted as pure time information, which represents a fictive operation duration of the considered picture element with assumed permanent maximum activation. The following description of the FIGS. 10a to 10c is started with the interpretation of the secondary wear value V_2, which is particularly practical, because different picture elements can be activated depending on a picture represented on a plasma screen 100 over an operation time with different kinds or different combinations of activation signal values, and a single characteristic line KL_2 is sufficient, in order to combine the wear processes of these different picture elements using the interpretation of the secondary wear value V_2 as pure time measurement.

Possibly existing non-linear connections between an actual activation signal value and the actual wear of a picture element can be taken into account by means of the already described weighting of the consecutive values S(n) of the activation signals S allocated to one picture element p(x,y) before the step 300 of the addition (FIG. 5).

The characteristic line KL_2 shown in FIG. 10a is characteristic for an illuminant used in the plasma screen 100 (FIG. 1), which usually has phosphorous compounds, and is permanently stored in a plasma screen controller of the plasma screen 100. For example, the characteristic line KL_2 can be recorded in a ROM memory or also in the secondary memory M_2 (FIG. 4). In a plasma screen equipped with real color function, which has three different types of picture elements corresponding to three basic colors R, G, B, three different characteristic lines are usually stored, because the illuminants used for the different basic colors have wear characteristics that differ from each other. In the following example, however, only one characteristic line KL_2 will considered:

The characteristic line KL_2 according to FIG. 10a indicates an allocation of residual brightness RH of 100% to 50% and the secondary wear values V_2 allocated to this residual brightness RH. New, unworn picture elements have correspondingly low wear values V_2 according to the left area of the characteristic line KL_2 and therefore also still have a residual brightness RH of 100%. This means that, if a picture element such as this is activated with a maximum brightness, that is, to 100%, it actually does output the full brightness of 100%. A highly worn picture element with a secondary wear value V_2=b has accordingly a low brightness of about c=80% (refer to point B in FIG. 10a) and an even more highly worn picture element with a secondary wear value V_2=a has accordingly a still lower residual brightness of about d=60% (refer to point A of FIG. 10a).

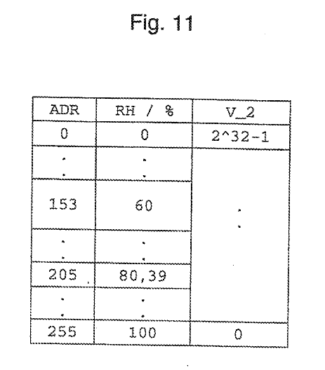

In order to store the characteristic line KL_2, 2̂8 memory cells according to the disclosure are provided, for example, so that a total of 256 different values for storing the residual brightness of between 0% and 100% are available. With this accuracy, the characteristic line KL_2 is permanently recorded in a non-volatile memory, such as, for example, the secondary memory M_2 in the form of the table shown in FIG. 11.

The table of FIG. 11 shows in its left column ADR the respective memory address of a memory cell, in which a considered residual brightness value RH is stored. By definition, the memory address can also directly correspond to a corresponding brightness, so that the column ADR must not be stored in the secondary memory M_2. In this case, a 32 bit secondary wear value V_2 is stored directly in the respectively memory cell, which is represented in a separate column in FIG. 11 for reasons of clarity. This means that a secondary wear value for a residual brightness 153/255=60% is directly stored, for example, at the memory address 153.

From the permanently recorded characteristic line KL_2, which shows the entire value range of the residual brightness RH of 0% to 100%, for example, in the form of the table of FIG. 11, a lookup table according to the disclosure during the operation of the device 110 is dynamically formed, which only manifests such a value range of residual brightness values RH that includes wear values V_2 which already actually occurred. In this way, the lookup table can have few values, for example, only a single value, which allocates a wear value V_2=0 to a residual brightness RH=100%, when a new plasma screen 100 is started, in which all the picture elements are still new and have the same maximum residual brightness of 100%.

With the operation of the plasma screen 100 (FIG. 1) gradually increasing wear values V_2 through the steps 300, 310, and 400 (FIG. 5) are produced, so that the existing initial lookup table no longer suffices in its value range for the wear values V_2 or also for the brightness values.

FIG. 10b shows for this purpose a histogram of a used plasma screen, with which the number N of picture elements is entered on the ordinate and the abscissa shows the residual brightness RH, as already shown in FIG. 10a. It can be seen, that most picture elements have a residual brightness in the interval delimited by the values c and d, while only very few picture elements have a greater or smaller residual brightness. A dynamically formed lookup table of the aforementioned type must comprise corresponding residual brightness values from c to d in such a plasma display.

As soon as it is determined when accessing the initial lookup table that there is a current wear value of V_2>0, to which a residual brightness cannot be allocated by means of the initial lookup table, a new lookup table is formed according to the disclosure. For this purpose, an interval of wear values is first defined which is covered by the new lookup table. Starting from the initial lookup table with the value range of V_2=0 appears, for example, a new wear value of V_2=2000, so that an interval of 0<=V_2<=2000 is to be taken into account for the newly formed lookup table. Starting from the 256 available memory cells for the storage of the new lookup table, any desired amount of the 256 memory cells can now be used for the allocation of wear values between 0 and 2000, which are obtained by using the characteristic line KL_2, to the corresponding residual brightness values depending on the desired resolution. The corresponding residual brightness values can be read out, for example, directly from the characteristic line KL_2, or from the table according to FIG. 10a which represents the latter, or by interpolation.

A maximum accuracy in the determination of residual brightness values is always provided by the dynamically formed lookup table depending on the wear values V_2.

As soon as a further wear value V_2 appears, which is in turn not covered by the currently valid lookup table, a lookup table with adapted value range is again dynamically formed. With increasing age and accordingly increasing wear of the picture elements, an offset of the histogram curve results/toward the right, so that residual brightness values no longer occur to the left of RH=c after a specific time. In this case, a new lookup table can also be formed, wherein the residual brightness range of the lookup table is reduced.

In order to fix the value range of a new lookup table, it is not necessary to measure the entire histogram curve of FIG. 10b, but it is sufficient to move the corresponding interval limit, for example, incrementally, in those cases in which wear values occur which exceed or fall below the value range of the currently valid lookup table or the interval defined thereby. According to the disclosure, the once determined interval limits c, d (FIG. 10b) are stored in a non-volatile memory, such as, for example, the secondary memory M_2, in order to also be available after a deactivation of the display device 100.

Instead of the connection between an occurring wear value V_2 and a residual brightness value RH, the lookup table can also directly contain a connection between the wear value V_2 and a correction value for the corrected activation of the picture elements. Therein, in order to form the lookup table, the respective correction value K as a dependent of the residual brightness should be determined, for example, from the characteristic line KL_2 as well as, if required, from additional calculation specifications recorded in the device 110.

Instead of using a permanently recorded characteristic line KL_2 according to FIG. 10a or 11, the characteristic line KL_2 can also be approximated by means of a suitable mathematical function, such as, for example, an exponential function. In this case, merely the parameters of the exponential function are stored in the device 110, and upon an activation of the device 110, for example, the required values of the characteristic line KL_2 can be calculated from the exponential function and its predetermined parameters with an activation of the device 110. Storage of the calculated values is also possible, for example, in the form of the table shown in FIG. 11, for example, in a volatile memory M_1 of the computer unit 120, so that in addition a lookup table can again be dynamically formed from this table.

It is also possible to only record the exponential function and its parameters and to directly form from these, if required, a new lookup table by evaluating the exponential function.

The formation of a new lookup table must not necessarily be carried out after the first occurrence, for example, of a wear value V_2 that is not comprised within the value range which is covered by the current lookup table. Rather, it is possible not to count the occurrence of wear values V_2 that are not comprised in the current lookup table, and to only form a new lookup table when a predetermined threshold value is exceeded.

In order to likewise dynamically adapt the residual brightness value c of FIG. 10b, that is, the left edge of the histogram curve, and in order to, if necessary, reduce the lookup table according to its value range as soon as a sufficient number of picture elements have a residual brightness that is located to the right of the value c in FIG. 10b, the number of wear values V_2 which fall below a predetermined minimum value can be constantly determined, for example, for every picture. As soon as this number falls below a corresponding threshold value, i.e., as soon as the left edge of the histogram curve at RH=c is offset further toward the right in FIG. 10c, a new lookup table can be formed.

Wear values that are not comprised within the value range of the lookup table can be assigned a predetermined table value, which corresponds, for example, to one end of the value range provided in the lookup table.

With the application of the process with display devices according to the disclosure having organic light emitting diodes (OLED), a purely time-dependent wear value component, which takes into account the fact that OLED picture elements also show wear when they are not activated, that is, in particular also when the display device 100 is deactivated, can be considered in addition to a contribution to the wear values V_1, V_2 resulting from the activation signal S or the corrected activation signal S′.

For this purpose, the system time obtained from an actual time clock integrated in a display device 100 is stored in a non-volatile memory before the display device is deactivated, and a switch-off time can be determined using the current system time in an additional activation of the display device 100. A numeric value corresponding to this switch-off time can be added then, for example, to the secondary wear value V_2, in order to take into account the wear of the display device 100 during the switch-off period. A numeric value determined for the operating time of the display device 100 can likewise be added to the secondary wear value V_2, in order to take into account the purely time-dependent wear proportion of the OLED picture elements. These purely time-dependent wear proportions of the OLED picture elements are also temperature-dependent and can be accordingly weighted before the addition to the secondary wear value V_2.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A process for operating a display device (100) with a multitude of picture elements (p) affected by wear and arranged in matrix form, in which each picture element (p) is actuated by an allocated activation signal (S), in which a wear value (V) is determined for each picture element (p) depending on the activation signal (S) as a measure of the individual wear of the respective picture element (p), and in which a correction value (K) for correcting the activation signal (S) is determined depending on the wear value (V), wherein the determination of the wear value (V) comprises the following steps:
Adding (300) chronologically consecutive values S(n) of the activation signal (S) allocated to the picture element (p), in order to obtain a primary wear value (V_1),
Storing (310) the primary wear value (V_1) in a primary memory (M_1), and
At least partially transferring (400) the primary wear value (V_1) by reducing (410) the primary wear value (V_1) by a predetermined transfer value (UE) and by adding the transfer value (UE) to a secondary wear value (V_2) stored in a secondary memory (M_2).

2. The process of claim 1, wherein the step of the transfer (400) is carried out after a predetermined condition is reached, after at least one of: (a) exceeding a maximum primary wear value (V_1_max); and (b) a predetermined waiting time has expired.

3. The process of claim 1, wherein a maximum value range of the transfer value (UE) is fixed by a specification of the maximum number of high-value bits of the primary wear value (V_1) to be transferred.

4. The process of claim 1, wherein chronologically consecutive values (S′(n)) of the corrected activation signal (S′) allocated to the picture element (p) are added in the addition step (300), in order to obtain the primary wear value (V_1).

5. The process of claim 1, wherein the primary wear value (V_1) of a picture element (p) and a correction value (K) allocated to this picture element (p) are simultaneously stored in a memory cell (M_1 (x,y)) of the primary memory (M_1).

6. The process of claim 5, wherein a memory cell (M_1 (x,y)) of the primary memory (M_1) has a total of m bits and wherein the primary wear value (V_1) is recorded in m_1<m high-value bits of the memory cell (M_1 (x,y)) and wherein the correction value (K) is recorded in m_2=m—m_1 low-value bits of the memory cell (M_1 (x,y)).

7. The process of claim 1, wherein the steps of adding (300) and storing (310) in the primary memory (M_1) are carried out by at least one of different times and asynchronously with respect to the step of the at least partial transfer (400).

8. The process of claim 1, wherein the steps of adding (300) and storing (310) in the primary memory (M_1) are carried out with a processing speed that corresponds to the data rate of the activation signal (S).

9. The process of claim 1, wherein the primary wear values (V_1) are stored in the primary memory (M_1) in a manner that corresponds to the chronological order of the values of the activation signal (S).

10. The process of claim 1, wherein the at least partial transfer (400) of the primary wear value (V_1) is carried out with a lower processing speed than the addition (300) and the storage (310) in the primary memory (M_1).

11. The process of one of claim 1, wherein the secondary wear values (V_2) are stored block-by-block in the secondary memory (M_2).

12. The process of claim 11, wherein a block identification is stored in the secondary memory (M_2) together with the secondary wear values (V_2), which are stored block-by-block.

13. The process of claim 1, wherein a test sum is allocated to several secondary wear values (V_2) and the test sum is recorded in the secondary memory (M_2).

14. The process of claim 1, wherein a volatile memory is used as a primary memory (M_1).

15. The process of claim 1, wherein a non-volatile memory is used as secondary memory (M_2).

16. The process of claim 1, wherein the step of the adding (300) and storing (310) comprise the following steps:
Reading out (302) a primary wear value (V_1_old) already stored in the primary memory (M_1),
Adding (304) the current value of the activation signal (S) allocated to the picture element (p) to the previous primary wear value (V_1_old), in order to obtain a current primary wear value (V_1_new), and
Storing (312) the current primary wear value (V_1 _new) in a form of the primary wear value (V_1).

17. The process of claim 1, wherein the step of adding the transfer value (UE) comprises the following steps:
Reading out (422) a secondary wear value (V_2_old) already stored in the secondary memory (M_2),
Adding (424) the transfer value (UE) to the previous secondary wear value (V_2_old), in order to obtain a current secondary wear value (V_2_new), and
Storing (426) the current secondary wear value (V_2_new) in a form of the secondary wear value (V_2).

18. The process of claim 1, wherein the transfer step (400) is carried out before the display device (100) is deactivated, while the primary wear values (V_1) are transferred respectively in at least one of their entirety and the correction values (K) are transferred into the secondary memory (M_2).

19. The process of claim 1, wherein at least one of: the secondary wear values (V_2) are stored in the secondary memory (M_2) and the correction values (K) are first transferred into the primary memory (M_1) after the display device (100) is deactivated.

20. The process of claim 1, wherein the determination of the correction value (K) comprises the following steps:
Reading in the wear value, preferably the secondary wear value (V_2) stored in the secondary memory (M_2), and
Determining a correction value (K) corresponding to the read-in wear value (V_2), which is fed for this purpose to the read-in wear value (V_2), by at least one of a characteristic line (KL) and a characteristic field.

21. The process of claim 20, wherein the characteristic line (KL) allocates a wear value interval (V(i)) having at least one wear value to every possible correction value (K(i)), and wherein a correction value (K(i)) allocated to a read-in wear values (V_2) is determined by determining that wear value interval (V(i)) in which the read-in wear value (V_2) is located.

22. The process of claim 21, wherein the wear value interval (V(i)) in which the read-in wear value (V_2) is located is determined by means of a binary search of the wear value intervals (V(i)).

23. The process of claim 10, wherein a lookup table is dynamically built, which has an allocation between at least one of correction values (K) and residual brightness values (RH) and the wear values (V_2).

24. The process of claim 23, wherein a value range comprised by the lookup table is determined depending on the occurring wear values (V_2).

25. The process of claim 24, wherein the interval limits (c, d) that define the value range are stored in a non-volatile manner.

26. The process of claim 1, wherein a predetermined number of low-value bits of the activation signal (S) is not used to determine the primary wear value (V_1).

27. The process of claim 1, wherein the correction value (K) has a resolution that is lower than that of the activation signal (S).

28. The process of claim 1, wherein the determination of the correction value (K) is carried out by at least one of different times and asynchronously with respect to the steps of the addition (300) and the storage (310) in the primary memory (M_1) and the at least partial transfer (400).

29. The process of claim 1, wherein the correction value (K) is transferred from the primary memory (M_1) into the secondary memory (M_2), together with the primary wear value (V_1).

30. The process of claim 1, wherein a weighting of the values (S(n)) to be added is carried out before the addition in the step (300) in which the chronologically consecutive values S(n) of the activation signal (S) allocated to the picture element (p) are added.

31. The process of claim 30, wherein the weighting is used to reproduce a change of the activation signal (S), especially a gamma correction, by a plasma display controller.

32. A device (110) for the correction of a control signal (S) for a display device (100), having a multitude of picture elements (p) affected by wear and preferably arranged in matrix form, which can be actuated by an activation signal (S) allocated to the picture element (p), in which a wear value (V) can be determined for each picture element (p) depending on the activation signal (S) as a measure of the individual wear of the respective picture element (p), and a correction value (K) for correcting the activation signal (S) can be determined depending on the wear value (V), in which the device (110) has a primary memory (M_1) for storing a primary wear value (V_1) and a secondary memory (M_2) for storing a secondary wear value (V_2).

33. The device (110) of claim 32, wherein a correction value (K) allocated to the picture element (p) is simultaneously stored in a memory cell (M_1 (x,y)) of the primary memory (M_1).
